(19) United States
(12) Patent Application Publication
(10) Pub. No.: US 2015/0264948 A1
(43) Pub. Date: Sep. 24, 2015

(54) PORTABLE SMOKER OVEN

(71) Applicant: Bruce Gridley, Sparta, NC (US)

(72) Inventor: Bruce Gridley, Sparta, NC (US)

(21) Appl. No.: 14/220,470

(22) Filed: Mar. 20, 2014

(51) Int. Cl. A23B 4/052

(52) U.S. Cl. CPC A23B 4/052; A23B 4/0523

(57) ABSTRACT

A portable smoker oven comprising a framed housing, where the housing includes a set of top edges, a set of bottom edges and a set of side edges to comprise a cuboidal structure; detachable supports attached to the side edges to support a cooking rack; a fuel container at a bottom of the housing, where the fuel container contains a fuel source; a nonflammable material draped over the framed housing, where the nonflammable material includes at least one vent by the bottom edge of the framed housing; a chimney hole in a top surface of the nonflammable material to allow smoke to escape the framed housing; a plurality of securing means to secure the nonflammable material to the framed housing; an opening at a front face of the nonflammable material; and a pair of flaps over the opening, where the pair of flaps close the opening with at least one closure.

### BACKGROUND OF THE INVENTION

1. Field of the Invention

The present invention relates to a smoker oven that is compactable and portable to enable relocation as desired by the user.

2. Description of Related Art

Smoking meats is a unique cooking method which imparts a distinct flavor into the meat. The flavored is enjoyed by many people around the world, each using and developing their own custom methods. Smoking originated as a way to preserve protein rich foods that would otherwise spoil after extended periods of time. As the technique developed over the years different flavors were created rendering the meat a great delicacy in many cultures. Additionally, as the cooking technology expanded greater meat quantities are produced as well as more choices of where the meat is smoked.

Because of the great demand and enjoyment of smoked meats, portable smokers are a desired feature in many smoker ovens. There are even food competitions utilizing portable smokers requiring the competitors to wheel their own equipment to the event location. Typically the portable smokers are large, cumbersome structures that are difficult to move and even harder to operate. Due to their size and weight their use is often limited. Some smokers are supported on wheels so they may be rolled to their desired location. Alternatively, other smokers have been incorporated into a vehicle thereby providing an engine to transport the smoker as needed. While the wheels and even vehicle incorporation are convenient, the smokers are still difficult to transport thereby limiting how often they are moved and even used.

Based on the foregoing, it would be desirable in the art to provide a smoker that is easily transported and constructed by a user. It would also be desirable in the art to provide a smoker that is able to deconstruct for portability thereby allowing set up in any location desired by the user.

### SUMMARY OF THE INVENTION

In view of the foregoing disadvantages inherent in the prior art, the general purpose of the present invention is to provide a lightweight, portable smoker, configured to include all of the advantages of the prior art, and to overcome the drawbacks inherent therein.

Accordingly, an object of the present invention is to provide a portable smoker oven that is made from a lightweight framed housing enveloped within a nonflammable material.

Another object of the present invention is to provide a portable smoker oven with a detachable housing to enable disassembly after use.

To achieve the above objects, in an aspect of the present invention, a portable smoker oven is described comprising a framed housing, where the housing includes a set of top edges, a set of bottom edges and a set of side edges to comprise a cuboidal structure; detachable supports attached to the side edges to support a cooking rack; a fuel container at a bottom of the housing, where the fuel container contains a fuel source; a nonflammable material draped over the framed housing, where the nonflammable material includes at least one vent by the bottom edge of the framed housing; a chimney hole in a top surface of the nonflammable material to allow smoke to escape the framed housing; a plurality of securing means to secure the nonflammable material to the framed housing; an opening at a front face of the nonflammable material; and a pair of flaps over the opening, where the pair of flaps close the opening with at least one closure.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a front view of a portable smoker oven in accordance with an exemplary embodiment of the present invention;

FIG. 2 depicts a front view of a portable smoker oven covered with a nonflammable material in accordance with an exemplary embodiment of the present invention;

FIG. 2(A) depicts a front view of a portable smoker oven covered with a nonflammable material in accordance with an alternative embodiment of the present invention.

FIG. 3 depicts a side view of a portable smoker oven in accordance with an exemplary embodiment of the present invention; and

FIG. 4 depicts a top view of a portable smoker oven in accordance with an exemplary embodiment of the present invention.

Like reference numerals refer to like parts throughout the description of several views of the drawings.

### DETAILED DESCRIPTION OF THE DRAWINGS

The present invention relates to a smoker oven that is compactable and portable to enable relocation as desired by the user. The present invention provides a portable smoker oven to smoke large pieces of meat with ease in any location. The portable smoker oven is a tent like structure covered with a fire resistant material. The fire resistant material features an air vent and is held in place with a set of magnets. The entire structure is easily dismantled and folded to facilitate transportability if and when desired. A range of fuel methods may be used as preferred by the user thus allowing greater convenience over conventional smokers.

Turning now descriptively to the drawings, referring to FIG. 1, a front view of a portable smoker oven 100 is shown in accordance with an exemplary embodiment of the present invention. The portable smoker oven 100 comprises a framed housing 102 shaped preferably as a cuboidal structure including a top edge 104, a bottom edge 106, and a set of side edges 108. The housing 102 may be made from an aluminum or metal alloy material to provide a strong, lightweight, nonflammable structure for cooking

Along the side edges 108 of the housing 102 are a plurality of supports 120. The supports 120 provide anchors, pins or rests upon which a cooking rack 122 is positioned. One to four cooking racks 122 may be positioned within the housing 102 at once. The supports 120 are repositionable up and down along the side edges 108 thereby raising or lowering the cooking rack 122 as desired by the user depending on the size and amount of food being cooked.

At the bottom edge 106 of the housing 102 is a fuel source 110 to ignite a flame that is contained in a fuel container 111. The fuel source 110 may be wood, coal, or propane to allow for ease, and flavor customization as desired by the user. The fuel container 111 is a metal pan, sheet or canister to contain the fuel flames within the housing 102. Upon the cooking rack 122 a pan 124 may rest. The pan 124 may contain a cooking liquid like water, stock, broth, beer, wine, juice, vegetables, herb and spices or the like to moisturize and flavor the contained foods. The liquid within the pan 124 also helps to regulate the temperature from the fire while using the portable smoker oven 100.

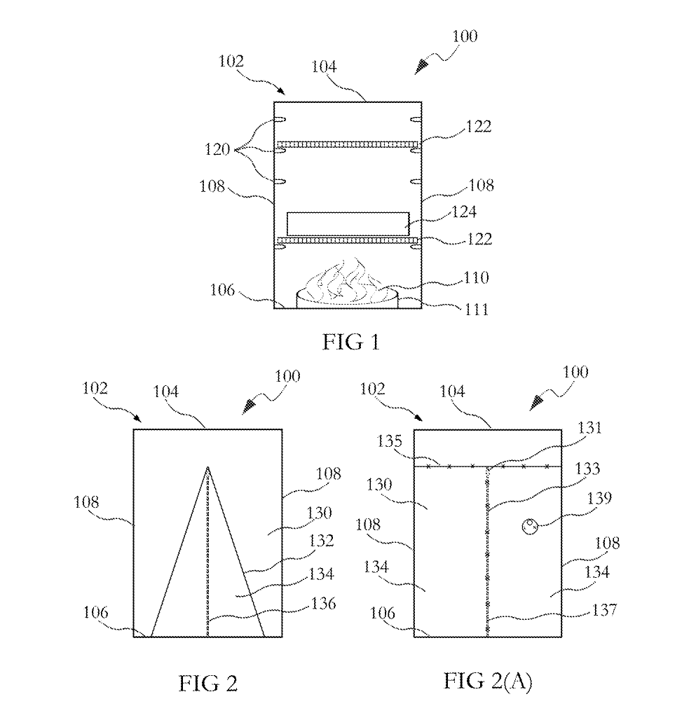

Referring now to FIG. 2, a front face view of the portable smoker oven 100 is shown covered with a nonflammable material 130 in accordance with an exemplary embodiment of the present invention. The top edges 104 and side edges 108 of the housing 102 are completely enveloped in the nonflammable material 130. The nonflammable material 130 creates a tent-like structure of the framed housing 102. The nonflammable material may be a Pyroblanket™ which is a lightweight, high temperature resistant fabric able to withstand the elevated temperature of cooking flames. The nonflammable material 130 includes an opening 132 on the front face that is covered with two flaps 134 that are joined together at a closure 136. The opening 132 provides access into the housing 102 to insert or retrieved the food. The closure 136 may be a nonflammable zipper or magnet closure that creates an airtight seal when the flaps 134 are in place over the opening 132.

FIG. 2(A) illustrates an alternative opening to the nonflammable material 130. The nonflammable material 130 may open along a horizontal seam 131 and a vertical seam 133 to separate the flaps 134. The horizontal seam 131 is positioned near the top edge 104, and the vertical seam 133 is positioned centrally between the side edges 108. The seams 131, 133 have coordinating closures with a horizontal closure 135 beneath the horizontal seam 131 and a vertical closure 137 along the vertical seam 133. The closures 135, 137 may be a nonflammable zipper or magnet as in the embodiment illustrated in FIG. 2. On the front face of the nonflammable material 130 may be a temperature indicator 139. The temperature indicator 139 informs the user as to the internal temperature of the portable smoker oven 100 when enveloped by the nonflammable material 130. This way the user is able adjust the flames and air flow accordingly for their ideal cooking temperature.

Referring now to FIG. 3, a side view of the portable smoker oven 100 is shown in accordance with an exemplary embodiment of the present invention. All of the side walls of the framed housing 102 are structured as now described and illustrated. The side edges 108 of the portable smoker oven 100 support a pair of bisecting poles 112 to support the side walls of the portable smoker oven 100. The bisecting poles 112 intersect at a joint 114 that pivots to enable the bisecting poles 112 to rotate about the joint 114. The bisecting poles 112 are detachable from the side edges 108.

The nonflammable material 130 drapes from the top edge 104 to the bottom edge 106. The nonflammable material 130 may be held in place against the housing 102 with a plurality of securing means 116. The securing means 116 may be magnets, hooks, snaps or the like able to withstand the high temperature of cooking The securing means 116 may be attached to each edge 104, 106, 108 to securely fasten the nonflammable material 130 to the framed housing 102. The nonflammable material 130 includes a vent 138 or opening to enable smoke and air to enter and escape the housing 102 when the nonflammable material 130 is in place. The vent 138 may be positioned near the bottom edge 106 to provide oxygen to the flames while cooking

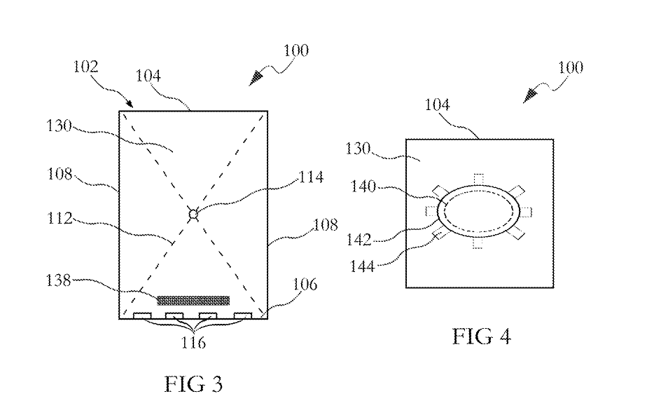

Finally referring to FIG. 4, a top view of the portable smoker oven 100 is shown in accordance with an exemplary embodiment of the present invention. The top portion of the nonflammable material 130 includes a chimney hole 140 which lets smoke to escape the housing 102. Covering the chimney hole 140 may be a cover 142 which adjustably allows the preferred amount of smoke and air to pass through the opening 140. The cover 142 is held in place with a plurality of magnets 144. With the magnets 144 the user is able to quickly and easily remove or replace the cover 142 thereby controlling the amount of smoke and air contained within the housing 102.

The portable smoker oven 100 provides the user with a lightweight and transportable cooking assembly. In one particular embodiment, the housing 102 may stand 4 feet tall, 3 feet in length, and 3 feet in width, however the actual size may vary beyond these particular parameters. The framed housing 102 is collapsible by enabling the top 104, bottom 106 and side 108 edges to detach from each other. The nonflammable material 130 also easily detaches from the framed housing 102, and is foldable for storage. After disassembling the housing 102 the portable smoker oven 100 is simple to carry, store and reconstruct when needed again by the user. With the portable smoker oven 100 the user is afforded a cooking structure able to smoke a large meat piece or great meat quantities at any desired location with ease.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A portable smoker oven comprising:
a. a framed housing, where the housing includes a set of top edges, a set of bottom edges and a set of side edges to comprise a cuboidal structure;
b. a plurality of detachable supports attached to the set of side edges;
c. at least two cooking racks positioned upon the supports, where the cooking rack is adjustable up and down within the framed housing by repositioned the plurality of detachable supports against the set of side edges;
d. a fuel container at a bottom of the housing, where the fuel container contains a fuel source, where the fuel source ignites a flame within the framed housing;
e. a nonflammable material draped over the framed housing, where the nonflammable material includes at least one vent by the bottom edge of the framed housing;
f. a chimney hole in a top surface of the nonflammable material, where the chimney hole allows smoke to escape the framed housing;
g. a plurality of securing means to secure the nonflammable material to the framed housing;
h. an opening at a front face of the nonflammable material; and
i. a pair of flaps over the opening, where the pair of flaps close the opening with at least one closure.

2. The portable smoker oven according to claim 1, where the framed housing is detachable.

3. The portable smoker oven according to claim 1, where the flammable material is secured to the framed housing with a plurality of securing means.

4. The portable smoker oven according to claim 3, where the plurality of securing means is one of at least magnets, hooks or snaps.

5. The portable smoker oven according to claim 1, where the chimney hole includes a cover to control the smoke escaping the housing, where the cover is held in place with a plurality of magnets.

6. The portable smoker oven according to claim 1, where the nonflammable material is a Pyroblanket™.

7. The portable smoker oven according to claim 1, where the fuel source is one of at least coal, wood or propane.

8. The portable smoker oven according to claim 1, where the set of side edges include a pair of detachable bisecting poles to support the sides of the framed housing, where the bisecting poles intersect at a pivot joint.

9. The portable smoker oven according to claim 1, where the lowest most cooking rack supports a pan containing a liquid, where the pan with liquid provides humidity and temperature regulation for the framed housing.

10. The portable smoker oven according to claim 1, where the closure is one of at least a magnet or zipper.

11. The portable smoker oven according to claim 1, where the opening includes a vertical seam and a horizontal seam to create the two flaps, where the horizontal seam includes a horizontal closure and where the vertical seam includes a vertical closure.

12. The portable smoker oven according to claim 1, where the nonflammable material includes a temperature indicator.
